(19) United States
(12) Patent Application Publication
(10) Pub. No.: US 2005/0275199 A1
(43) Pub. Date: Dec. 15, 2005

(54) Protective device for the driver of a motor vehicle

(75) Inventor: Matthias Helmstetter, Aschaffenburg (DE)

Correspondence Address: TAROLLI, SUNDHEIM, COVELL & TUMMINO L.L.P., 1111 LEADER BLDG., 526 SUPERIOR AVENE, CLEVELAND, OH, 44114-1400, US

(73) Assignee: TRW Automotive Safety Systems GmbH

(21) Appl. No.: 11/147,893

(22) Filed: Jun. 8, 2005

(30) Foreign Application Priority Data
Jun. 15, 2004 (DE) 20 2004 009 450.9

(51) Int. Cl. B60R 21/22

(52) U.S. Cl. 280/730.1; 280/732

(57) ABSTRACT

A protective device for the driver of a motor vehicle includes an airbag module (16). The airbag module (16) has an inflatable airbag (24). The airbag module (16) is arranged behind an instrument panel (12) of the vehicle. The airbag (24) in an inflated state extends in a space which is delimited substantially by a driver's door (26), an A-column (28) and a steering wheel (10) of the vehicle.

### TECHNICAL FIELD

The invention relates to a protective device for the driver of a motor vehicle, the protective device comprising an airbag module having an inflatable airbag.

### BACKGROUND OF THE INVENTION

In almost every modern vehicle, a protective device is provided for the driver, with an airbag module housed in the vehicle steering wheel. The airbag, unfolding out from the steering wheel, protects the driver in particular in the case of a frontal impact. Additional protection in the case of a lateral or oblique impact is offered, for example, by so-called “window bags” which unfold downwards from the roof area of the vehicle over the side windows, or by airbags which unfold directly out from the A-column. However, window bags do not necessarily belong to the standard equipment of a vehicle, nor can they be incorporated at all in particular types of vehicle like convertibles, for example. The function of airbags which are integrated into the A-column depends greatly on the vehicle geometry, in particular on the inclination of the A-column, and on the structural space available in the A-column.

It is therefore an object of the invention to provide an efficient additional protective measure for the driver, in particular in the case of a lateral or oblique impact, which is able to be realized independent of the vehicle type.

### BRIEF SUMMARY OF THE INVENTION

According to the invention, this is achieved by a protective device for the driver of a motor vehicle. The protective device comprises an airbag module having an inflatable airbag. The airbag module is arranged behind an instrument panel of the vehicle. The airbag in an inflated state extends in a space which is delimited substantially by a vehicle door, an A-column and a steering wheel of the vehicle. The protective device according to the invention can be incorporated into any type of vehicle and can be adapted to the structural conditions of the interior. The protective device offers an effective supplementary protection for the driver by filling the region between the driver's door, the A-column and the steering wheel with an airbag. The structural space available behind the instrument panel, in particular between the driver's door and the steering wheel, is utilized in an optimum manner.

According to a further development of the invention, in its inflated state the airbag assumes a position in which the airbag supports a steering wheel airbag which has emerged from the steering wheel of the vehicle. Thereby, the function of the steering wheel airbag, in particular in the case of an oblique impact, can be distinctly improved, because with a decentral plunging in of the driver, the steering wheel airbag can not escape laterally. A slipping of the driver from the steering wheel airbag is therefore avoided.

### BRIEF DESCRIPTION OF THE DRAWINGS

FIG. 1 shows the interior of a vehicle with a protective device according to the invention, from the view of the driver; and

FIG. 2 shows the interior with an activated protective device.

### DETAILED DESCRIPTION OF THE PREFERRED EMBODIMENT

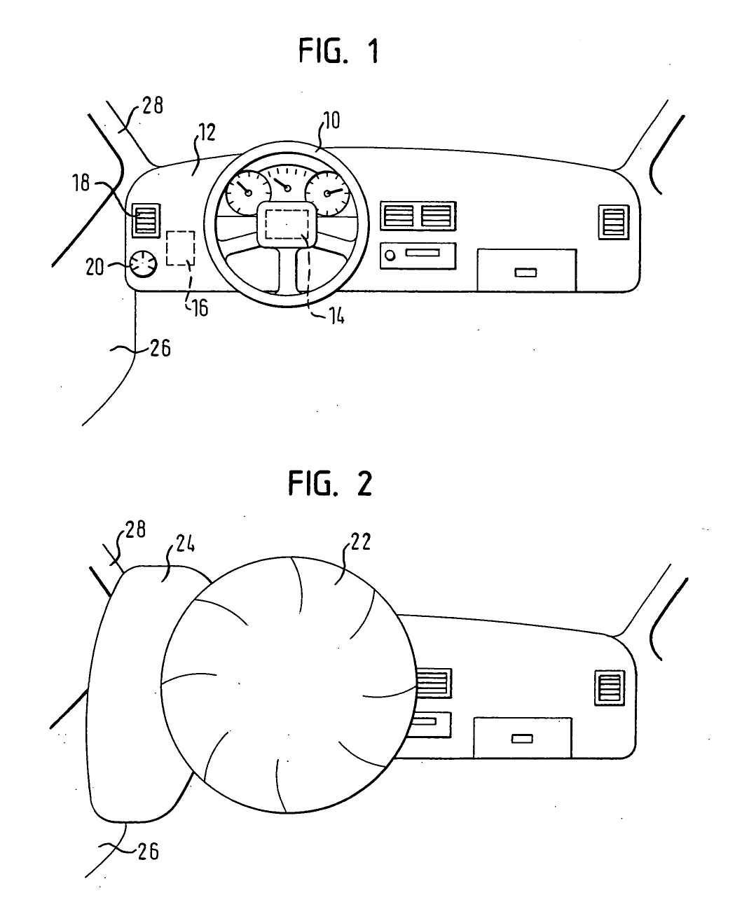

In FIG. 1 the interior of a vehicle is illustrated with a steering wheel 10 and an instrument panel 12. First and second airbag modules 14 and 16 are housed in the steering wheel 10 and behind the instrument panel 12, respectively. The second airbag module 16 is situated in a region between the steering wheel 10 and the driver's door 26, more precisely adjacent to a lateral interior ventilator 18 and a light switch 20 of the vehicle, which are both mounted near the left lateral end of the instrument panel 12.

FIG. 2 shows the interior of the vehicle with an activated protective device. A steering wheel airbag 22 has unfolded in a known manner from the steering wheel 10. From the second airbag module 16 arranged behind the instrument panel 12 an additional airbag 24 has emerged, which in its inflated state extends in a space which is delimited by the driver's door 26, the A-column 28 and the steering wheel 10 of the vehicle. It can also be seen that the airbag 24 assumes a position in which it supports the steering wheel airbag 22, so that with a plunging in of the driver, the steering wheel airbag 22 maintains a stable position.

1. A protective device for the driver of a motor vehicle, said protective device comprising an airbag module, said airbag module having an inflatable airbag, said airbag module being arranged behind an instrument panel of said vehicle, said airbag in an inflated state extending in a space which is delimited substantially by a driver's door, an A-column and a steering wheel of said vehicle.

2. The protective device according to claim 1, wherein said airbag module is housed between said steering wheel and said driver's door.

3. The protective device according to claim 1, wherein said airbag module is housed in a region of an interior ventilator of said vehicle, said ventilator being mounted near a lateral end of said instrument panel.

4. The protective device according to claim 1, wherein said airbag module is housed in a region of a light switch of said vehicle, said lift switch being mounted on said instrument panel.

5. The protective device according to claim 1, wherein the airbag in the inflated state assumes a position in which the airbag supports a steering wheel airbag which has emerged out from the steering wheel of the vehicle.
